(19) United States
(12) Patent Application Publication
(10) Pub. No.: US 2003/0153207 A1
(43) Pub. Date: Aug. 14, 2003

(54) Wire connector

(76) Inventor: Xing-Chuan Lin, Taichung (TW)

Correspondence Address: Xing-Chuan Lin, 58 MA YUAN WEST ST., TAICHUNG, TW

(21) Appl. No.: 10/073,812

(22) Filed: Feb. 8, 2002

(51) Int. Cl. H01R 4/24

(52) U.S. Cl. 439/402

(57) ABSTRACT

A wire connector has a main socket, a connecting tube connected to the main socket, a metal insertion frame, and an upper cover. The main socket has an inner chamber. A protruded bar is disposed in the main socket. A plurality of separation bars are disposed in the main socket. The upper cover has a lower flange and a cross-shaped groove. The connecting tube has a first through hole and a second through hole. The metal insertion frame has an upper crossbar, a first fork, and a second fork. The metal insertion frame is inserted in the upper cover. The upper cover engages with the main socket.

### BACKGROUND OF THE INVENTION

The present invention relates to a wire connector. More particularly, the present invention relates to a wire connector which

Referring to FIG. 5, a conventional wire connector has a main socket 11, a connecting tube 112 connected to the main socket 11, a metal insertion plate 12, and an upper cover 13. The main socket 11 has an inner chamber 111 to receive the metal insertion plate 12. The upper cover 13 has a lower flange 131. The connecting tube 112 has two through holes 113 to receive two wires 100. Each wire 100 has a metal cord 102 and a plastic sheath 101 enclosing the metal cord 102. The insertion plate 12 has two slots 121. The metal insertion plate 12 is disposed in the upper cover 13. The upper cover 13 engages with the main socket 11 so that the metal insertion plate 12 penetrates the plastic sheath 101 of each wire 100. However, the metal insertion plate 12 will be skewed while the metal insertion plate 12 penetrates the plastic sheath 101 of each wire 100. Therefore, the metal insertion plate 12 will contact a small portion of the metal cord 102 of each wire 100. When the metal insertion plate 12 penetrates the plastic sheath 101 of each wire 100 sharply, the metal cord 102 of each wire 100 will be easily cut off. Furthermore, the conventional wire connector cannot be used for a cable. The conventional wire connector receives small wires such as telephone wires.

### SUMMARY OF THE INVENTION

An object of the present invention is to provide a wire connector which connects two wires quickly and safely.

Another object of the present invention is to provide a wire connector which connects various wires such as electric wires, telephone wires, and cables.

Accordingly, a wire connector comprises a main socket, a connecting tube connected to the main socket, a metal insertion frame, and an upper cover. The main socket has an inner chamber. An insulation adhesive is disposed in the inner chamber of the main socket. A protruded bar is disposed in the main socket. A plurality of separation bars are disposed in the main socket. The upper cover has a lower flange and a cross-shaped groove. The connecting tube has a first through hole and a second through hole. The metal insertion frame has an upper crossbar, a first fork, and a second fork. The first fork has a slot and a curved groove communicating with the slot. The second fork has a slant edge. The metal insertion frame is inserted in the upper cover. The lower flange of the upper cover is inserted in the inner chamber of the main socket. The upper cover engages with the main socket.

### BRIEF DESCRIPTION OF THE DRAWINGS

FIG. 1 is a perspective exploded view of a wire connector of a preferred embodiment in accordance with the present invention;

FIG. 2 is a perspective assembly view of a wire connector of a preferred embodiment in accordance with the present invention;

FIG. 3 is a schematic view illustrating a metal insertion frame does not penetrate an insulation sheath of a cable and a plastic sheath of a wire;

FIG. 3A is a schematic view illustrating a metal insertion frame of a preferred embodiment penetrates an insulation sheath of a cable and a plastic sheath of a wire;

FIG. 4 is a schematic view illustrating a cable is inserted in a first through hole of a connecting tube of a preferred embodiment in accordance with the present invention;

FIG. 5 is a perspective exploded view of a conventional wire connector of the prior art.

### DETAILED DESCRIPTION OF THE INVENTION

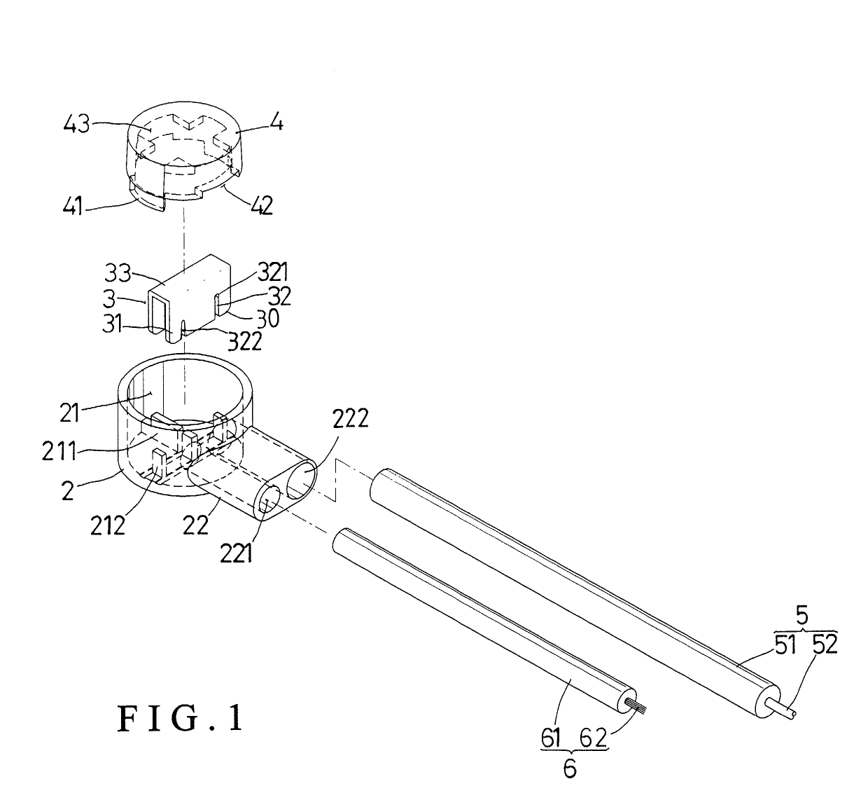

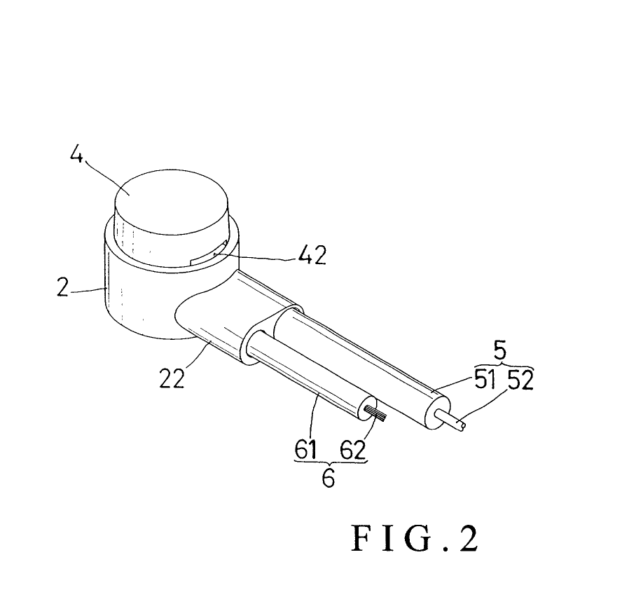

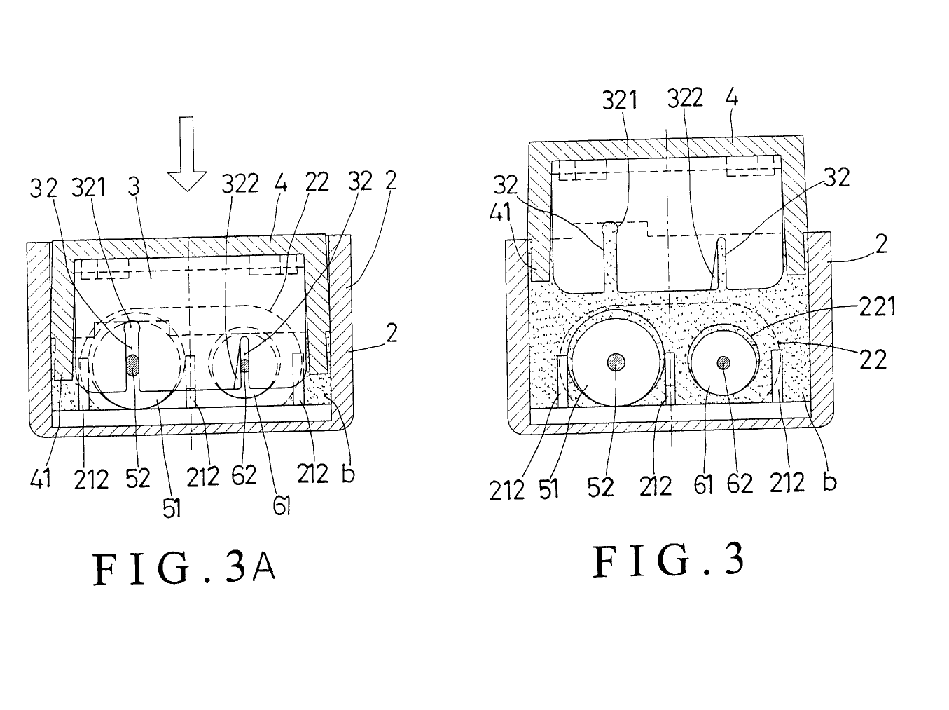

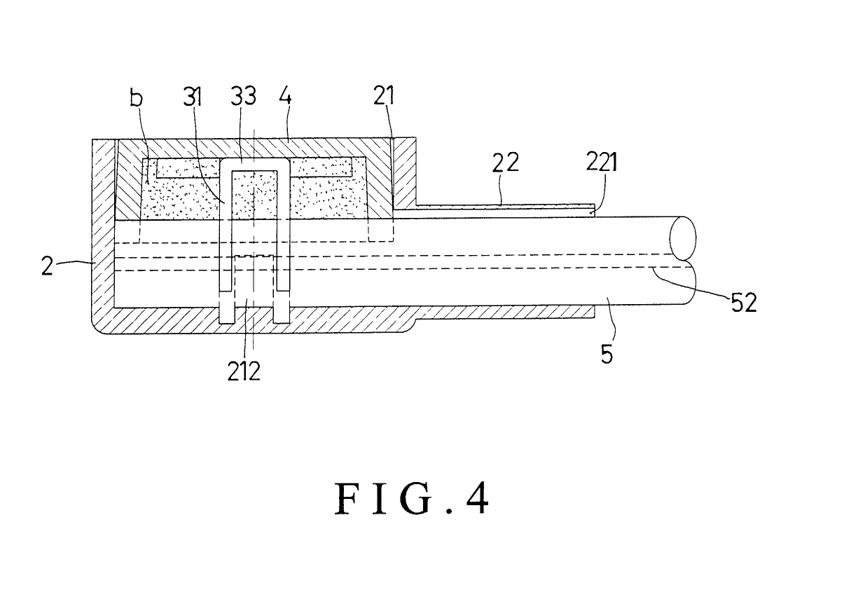

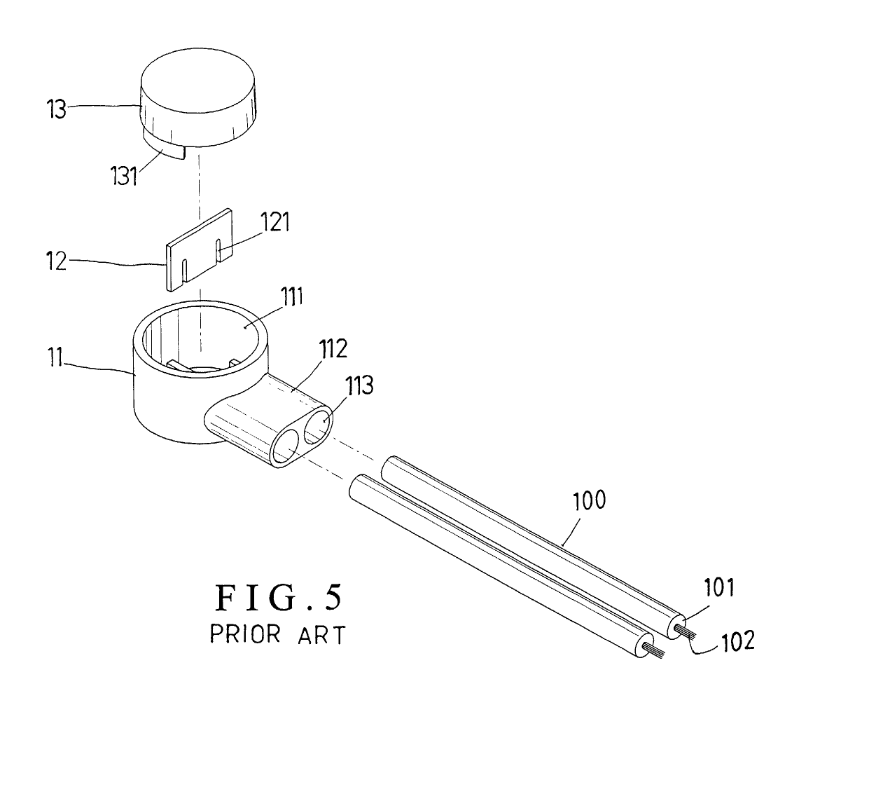

Referring to FIGS. 1 to 4, a wire connector comprises a main socket 2, a connecting tube 22 connected to the main socket 21, a metal insertion frame 3, and an upper cover 4.

The main socket 2 has an inner chamber 21.

An insulation adhesive b is disposed in the inner chamber 21 of the main socket 2.

A protruded bar 211 is disposed in the main socket 21.

A plurality of separation bars 212 are disposed in the main socket 21.

The upper cover 43 has a lower flange 41 and a cross-shaped groove 43.

The connecting tube 22 has a first through hole 222 to receive a cable 5 and a second through hole 221 to receive a wire 6.

The cable 5 has a copper cord 52 and an insulation sheath 51 enclosing the copper cord 52.

The wire 6 has a metal cord 62 and a plastic sheath 61 enclosing the metal cord 62.

The metal insertion frame 3 has an upper crossbar 33, a first fork 30, and a second fork 31.

The first fork 30 has a slot 32 and a curved groove 321 communicating with the slot 32.

The second fork 31 has a slant edge 322.

The metal insertion frame 3 is inserted in the upper cover 4.

The lower flange 41 of the upper cover 4 is inserted in the inner chamber 21 of the main socket 2.

The upper cover 4 engages with the main socket 11 so that the metal insertion frame 3 penetrates the plastic sheath 61 of the wire 6 and the insulation sheath 51 of the cable 5.

The inner chamber 21 of the main socket 2 receives the metal insertion frame 3.

The upper cover 43 further has a lower notch 42.

A diameter of the first through hole 222 of the connecting tube 22 is larger than a diameter of the second through hole 221 of the connecting tube 22.

The first fork 30 penetrates the insulation sheath 51 of the cable 5.

The second fork 31 penetrates the plastic sheath 61 of the wire 6.

The wire connector of the present invention has the following advantages.

The wire connector of the present invention has a novel feature in order to connect various wires such as electric wires, telephone wires, and cables together.

The wire connector of the present invention uses a few elements in order to reduce the total cost of manufacture.

It is easy to use the wire connector of the present invention so that a user need not strip off the plastic sheath of the wire and the insulation sheath of the cable.

The user need not wind the wire and the cable together with an insulation tape.

The insulation adhesive of the present invention prevents water from entering the wire connector through the first through hole and the second through hole of the connecting tube.

Since the metal insertion frame has an upper crossbar, the metal insertion frame will not be skewed while the first fork penetrates the insulation sheath of the cable and the second fork penetrates the plastic sheath of the wire.

When an electric source is not turned off, an operation of the wire connector of the present invention is safe for the user.

The present invention is not limited to the above embodiment but various modification thereof may be made. Furthermore, various changes in form and detail may be made without departing from the scope of the present invention.

I claim:

1. A wire connector comprises:
a main socket, a connecting tube connected to the main socket, a metal insertion frame, and an upper cover,
the main socket having an inner chamber,
an insulation adhesive disposed in the inner chamber of the main socket,
a protruded bar disposed in the main socket,
a plurality of separation bars disposed in the main socket,
the upper cover having a lower flange and a cross-shaped groove,
the connecting tube having a first through hole and a second through hole,
the metal insertion frame having an upper crossbar, a first fork, and a second fork,
the first fork having a slot and a curved groove communicating with the slot,
the second fork having a slant edge,
the metal insertion frame inserted in the upper cover,
the lower flange of the upper cover inserted in the inner chamber of the main socket, and
the upper cover engaging with the main socket.

2. The wire connector as claimed in claim 1, wherein the upper cover further has a lower notch.

3. The wire connector as claimed in claim 1, wherein a diameter of the first through hole of the connecting tube is larger than a diameter of the second through hole of the connecting tube.
